(19) United States
(12) Patent Application Publication
(10) Pub. No.: US 2006/0164753 A1
(43) Pub. Date: Jul. 27, 2006

(54) External computer hard drive and heat-dissipating base thereof

(76) Inventor: Cheng Yu Huang, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/040,012

(22) Filed: Jan. 24, 2005

(51) Int. Cl. G11B 33/14

(52) U.S. Cl. 360/97.02

(57) ABSTRACT

An external computer hard drive and heat-dissipating base thereof is provided. The heat-dissipating base corresponds to the external hard drive. The external hard drive provides an easy structure for installing and replacing the external hard drive, and emits light from a housing on standby. The heat-dissipating base is a circular or rectangular base with a heat-dissipating fan disposed inside. The rotation speed of the heat-dissipating fan can be adjusted. When in use, the external hard drive is engaged on top of the heat-dissipating base and presented in a horizontal or vertical position so as to assist heat dissipation.

### BACKGROUND OF THE INVENTION

Since computers have become popularly used, people have been enjoying the convenience these computers have brought. However, because of the differences in the variety in the methods of use and requirements, external hard drives are developed so as to provide users with convenient removable hard drive devices.

An external hard drive is placed outside of a personal computer for use. Furthermore, the power needed can be supplied by connecting the main computer system with signal wires, or even by directly connecting to direct current. Thus, the requirement for use should be simple and easy to operate. If the external appearance can be more appealing, the popularity can be more widely gained from the users.

The usual external hard drives on the market require dual screws for screwing and unscrewing during installation or replacement of internal parts. In other words, the hard drive is first secured on a supporting board with the screws, and after the supporting board and the hard drive are placed inside the main system, another screw is used to secure the outer cover on the main system, vise versa. Apparently, the screwing procedures are tedious and are hard to operate; additionally, the look of the system lacks visual appearance.

Furthermore, the external computer hard drive will become overheated when used over a long time. Because the easily overheating part is close to the hard drive, the internal hard drive can be damaged when overheating the external hard drive.

The usual heat-dissipating fan has a fixed rotation speed given by the manufacturer during manufacture in the factory. Users cannot adjust or set the rotation speed manually. Although fixing the rotation speed of the heat-dissipating fan can provide stability to airflow volume for heat dissipation, heat generated during an overloaded operation cannot be adequately dissipated in time.

Thus, the inventor developed the present invention of an external computer hard drive and heat-dissipating base thereof in view of the disadvantages of the prior products. The external hard drive provides a convenient structure for installation or replacement of the hard drive; additionally, the housing can emit light when the system is on standby. The heat-dissipating base is a circular or rectangular base that has an internal heat-dissipating fan. Furthermore, a device used to adjust the rotation speed of the fan is provided on the external hard drive or the heat-dissipating base. When in use, the external hard drive is engaged with the heat-dissipating base either vertically or horizontally so as to assist heat dissipation.

### SUMMARY OF THE INVENTION

The present invention provides an aluminum extrusion type of external computer hard drive and a heat-dissipating base for easily installing or replacing the hard drive. The external hard drive can emit light from the housing when it is on standby, while the heat-dissipating base is a circular or rectangular base that has an internal heat-dissipating fan. The rotation speed of the heat-dissipating fan can be adjusted. The present invention is characterized in that when in use, the external hard drive is engaged with the heat-dissipating base either horizontally or vertically so as to provide assistance to the heat dissipation of the external hard drive.

### BRIEF DESCRIPTION OF THE DRAWINGS

FIG. 1 is an exploded view of the main components in accordance with the present invention;

FIG. 2 is an exploded view of the main components in accordance with the present invention at another angle;

FIG. 3 is a three-dimensional view of an embodiment in a horizontal state in accordance with the present invention;

FIG. 4 is a three-dimensional view of an embodiment in a vertical state in accordance with the present invention;

FIG. 5 is a three-dimensional view of another embodiment in a vertical state in accordance with the present invention.

### DETAILED DESCRIPTION OF THE EMBODIMENTS

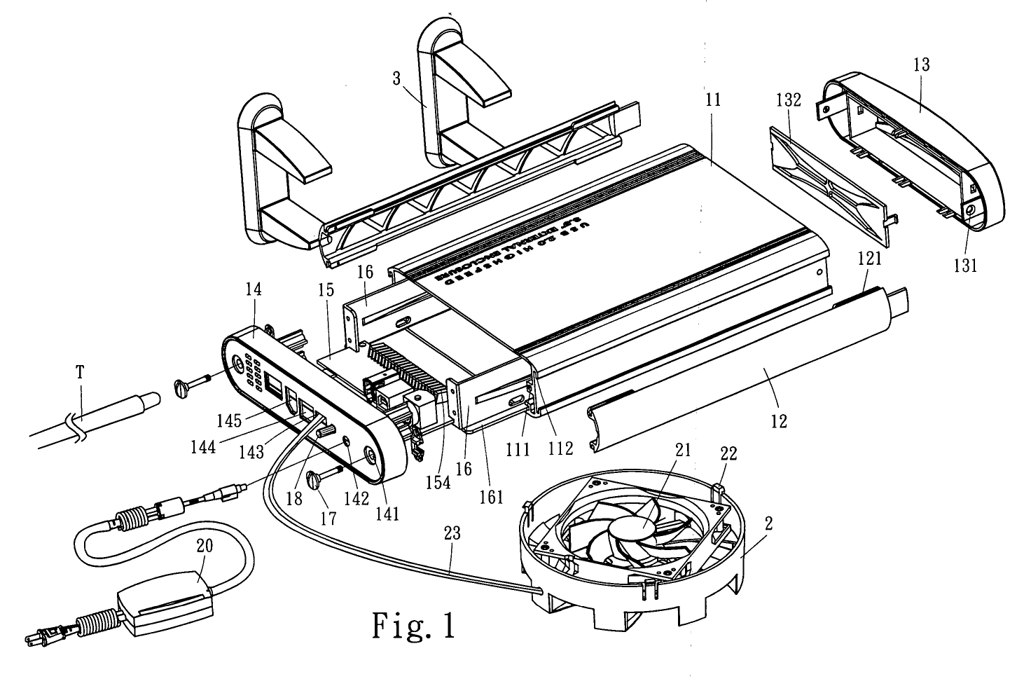

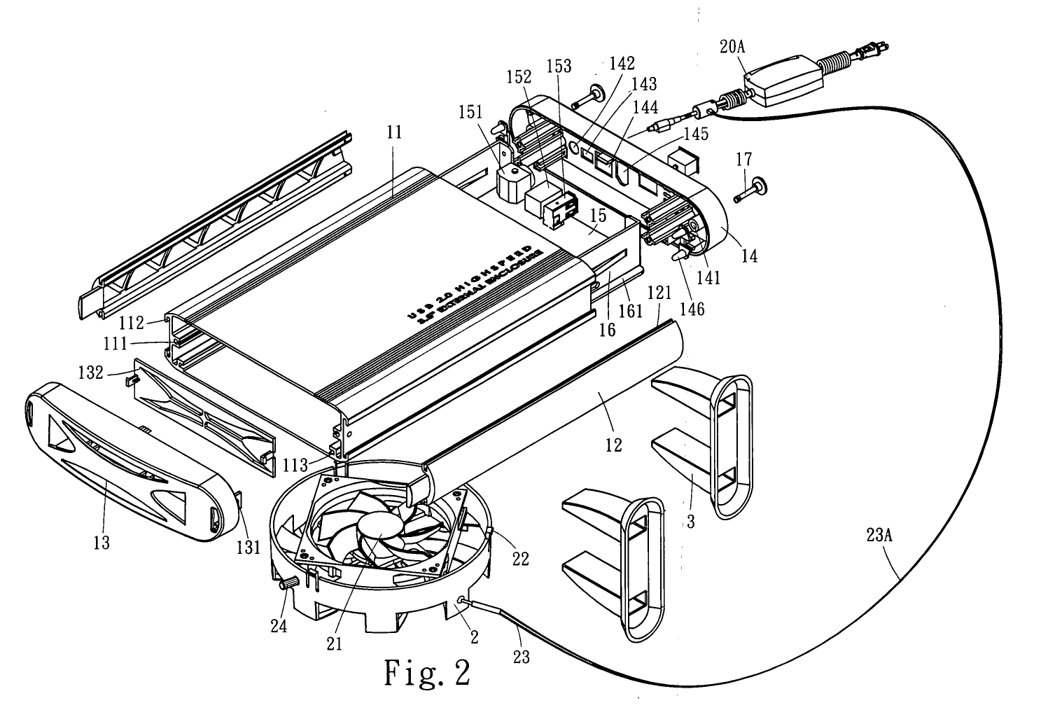

Refer to FIGS. 1 and 2. The present invention is an external computer hard drive and a heat-dissipating base, including an external computer hard drive 1 and a heat-dissipating base 2.

The external hard drive 1 mainly includes a body 11, a light-permeating sideboard 12, a front cover board 13, and a back cover board 14 made of a material that can easily dissipate heat such as aluminum.

The body 11 defines a hollow space inside. The inner edge of the two sides is provided with a screw-securing trough 111, and the outer edge is provided with a track trough 112. The sidewall around the hollow space is provided with a gliding trough 113. The track trough 112 can secure the symmetrical light-permeating sideboard 12 on the two sides by the protruding track 121 on the inner edge 121. The light-permeating sideboard 121 itself is made of a light transmitted material having the properties of light transmission and light emission.

The front cover board 13 having a screw hole 131 preserved on the two sides includes a cover board 132 and can be secured on one side of the body 11 by the screw.

The back cover board 14 is correspondingly provided with a screw hole 141, a power input hole 142, a power output hole 143, a signal input holes 144145 and a LED 146, while the back cover board 14 is secured with a circuit board 15 and a corresponding hard drive supporting board 16 at the inner edge. The two sides of the hard drive supporting board 16 have a gliding track 161 so as to secure the hard drive thereon.

The circuit board 15 is provided with a power input connector 151, a power output connector 152, and a signal input connector 153 corresponding to the power input hole 142, the power output hole 143, and the signal input hole 144145 on the back cover board 14. One corner of the circuit board 15 has a connector 154 connecting to the hard drive.

As shown in the figures, the back cover board 14 together with the hard drive supporting board 16 can slide into the sliding trough 113 of the body 1 via the gliding track 161 on the two sides, and be secured by screwing through the corresponding screwing hole 141 into the screwing trough 111 by hand or by simple tool for the screw with a T-shape top 17 so as to provide the convenience of securing or replacing the hard drive as mentioned above.

In addition, the heat-dissipating base 2 corresponding to the external hard drive 1 is a circular or rectangular base with a heat-dissipating fan 21 disposed therein. The upper edge of the base frame is provided with an engaging block 22, and the bottom of the body 11 is provided with the corresponding engaging hole not shown in the figure. Thus, the heat-dissipating base 2 can be engaged with the bottom of the external hard drive 1 so as to dissipate heat

The power of the heat-dissipating base 2 can be supplied in 2 ways: one is through a transformer 20 connecting to the power input hole 142 of the circuit board 15 and then connecting to the power output connector 152 of the circuit board 15 via a wire 23 so as to provide the power needed by the heat-dissipating fan 21. Another way is to use a parallel transformer 20A with a parallel wire by connecting the parallel wire 23A to the heat-dissipating base 2 so as to provide the heat-dissipating fan 21 with the power needed.

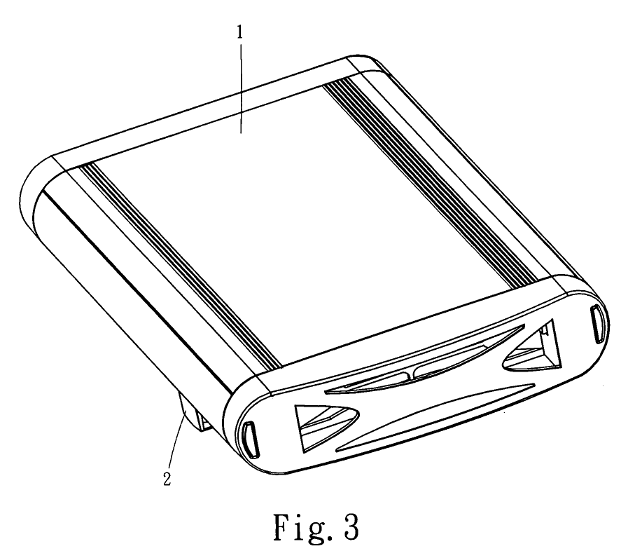

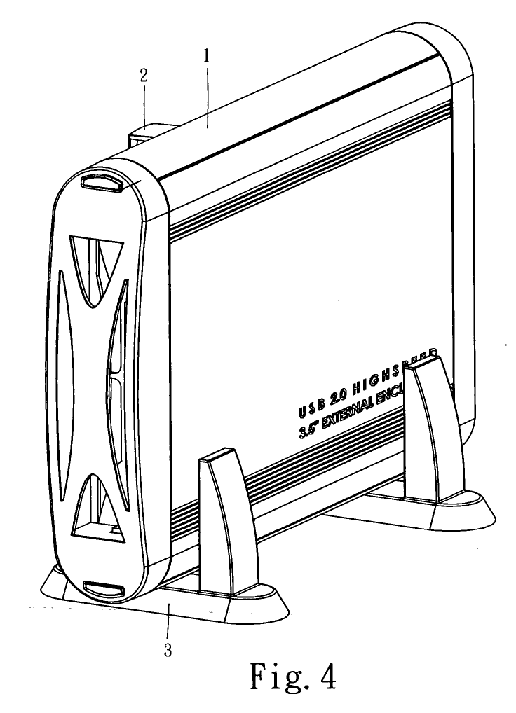

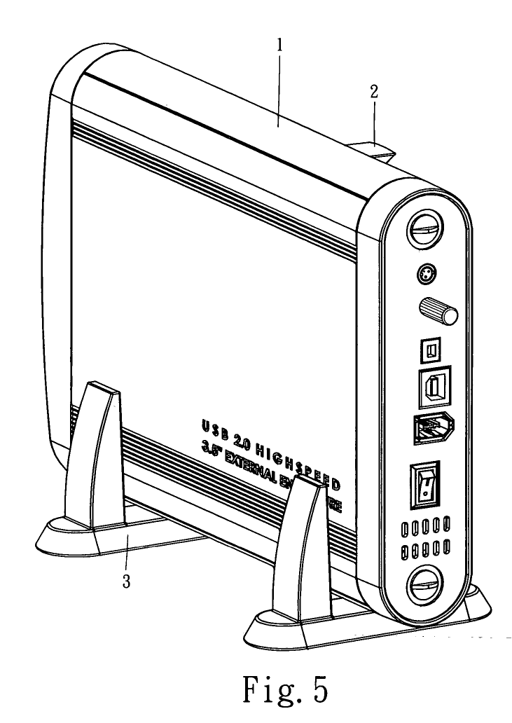

As shown in FIG. 3, the external hard drive 1 can be engaged with the heat-dissipating base 2 in a horizontal position for use in accordance with the present invention. Alternatively, as shown in FIGS. 4 and 5, the external hard drive 1 can be provided with a leg set 3 so as to be used vertically. Regardless if the position is horizontal or vertical, heat can be dissipated anytime.

Also, the external hard drive 1 or the heat-dissipating fan 2 of the present invention is provided with a rotation speed control button 18, 24 for the heat-dissipating fan 21 so as to adjust and control the rotation speed of the heat-dissipating fan 21 directly by hand.

What is claimed is:

1. An external computer hard drive and a heat-dissipating base, comprising an external hard drive and a heat-dissipating base, said heat-dissipating base being circular or rectangular in shape and provided with a heat-dissipating fan therein, an engaging hole provided at the bottom of a body of said external hard drive corresponding to an engaging block at the upper edge thereof so as to engage said heat-dissipating base with said bottom of said external hard drive to dissipate heat.

2. The external computer hard drive and heat-dissipating base of claim 1, wherein said external hard drive includes a body, a light-permeating sideboard, a front cover board, and a back cover board made of a material that can easily dissipate heat such as aluminum.

3. The external computer hard drive and heat-dissipating base of claim 2, wherein said body defines a hollow space inside, said two sides are provided with a screw-securing trough and a track trough, said sidewall around said hollow space is provided with a gliding track, said track trough can secure the symmetrical light-permeating sideboards on the two sides by the protruding tracks at the inner edge respectively, said light-permeating sideboard is made of a light transmitted material having the properties of light transmission and light emission.

4. The external computer hard drive and heat-dissipating base of claim 2, wherein screw holes are preserved at the two sides of the front cover board having a cover board so as to be secured on one side of said body by the screws.

5. The external computer hard drive and heat-dissipating base of claim 2, wherein said back cover board is provided with a screw hole, a power output hole, a signal input hole correspondingly, and the inner edge of said back cover board is secured with a circuit board and a corresponding hard drive supporting board, the two sides of said hard drive supporting board are provided with gliding tracks respectively to secure said hard drive thereon.

6. The external computer hard drive and heat-dissipating base of claim 5, wherein said circuit board is provided with a power input connector, a power output connector, a signal input connector and a signal output connector corresponding to said power input hole, said power output hole, said single input hole on said back cover board, and a corner of said circuit board is provided with a connector connecting to the hard drive.

7. The external computer hard drive and heat-dissipating base of claim 2, wherein said back cover board and said hard drive supporting board can slide into said track trough of said body through the gliding track on the two sides.

8. The external computer hard drive and heat-dissipating base of claim 2, wherein said back cover board and said body are assembled by screwing manually or with a simple tool through said corresponding screw holes on said back cover board and in said screw-securing trough so as to be secured.

9. The external computer hard drive and heat-dissipating base of claim 1, wherein two methods are provided to supply power: one is by connecting a transformer to said power input hole on said circuit board, then connecting to said power output connector on said circuit board via a connecting wire so as to supply power needed by said heat-dissipating fan; the other is to use a parallel transformer with a parallel wire to connect said parallel wire with said heat-dissipating base so as to supply power needed by said heat-dissipating fan.

10. The external computer hard drive and heat-dissipating base of claim 1, wherein said external hard drive and heat-dissipating base can be used horizontally after engagement or can be provided with a leg set so as to be used vertically to dissipate heat from said external hard drive.

11. The external computer hard drive and heat-dissipating base of claim 1, wherein a rotation speed control button is provided on said external hard drive or said heat-dissipating base so as to adjust and control said heat-dissipating fan by directly adjusting the rotation speed of said heat-dissipating fan manually.
